(19) United States
(12) Patent Application Publication
(10) Pub. No.: US 2012/0199374 A1
(43) Pub. Date: Aug. 9, 2012

(54) Universal stud or no stud mounted electrical boxes

(76) Inventor: Greg Herth, Oakdale, NY (US)

(21) Appl. No.: 12/931,717

(22) Filed: Feb. 8, 2011

(51) Int. Cl. H01H 9/02

(52) U.S. Cl. 174/58

(57) ABSTRACT

A universal type of electrical work box is mountable to studs for new work, or for old work whether stud-mounted or not. For mounting to studs, fastener blocks guide fasteners at an angle from the interior of the box. Alternatively, slide-in fastener plates which have integral fastener blocks can be used Optional recessed break-away flanges are provided to properly space the open end of the box from the front of a stud for new work use Flanges mounted flush with the open face of the box are used for old work whether stud mounted or not. When a box is to be mounted on wallboard or any wall covering away from a stud, rotating wings rotate 90 degrees away from the box wall and sandwich the wallboard between the tightened wings and the flush flanges are used.

### FIELD OF THE INVENTION

The present invention relates to universally mounted electrical boxes for old work and new work.

### BACKGROUND OF THE INVENTION

Electrical boxes are available for several types of applications. They come in rectangular shapes for one gang to many gangs; they are also available as round boxes. They are specified for “new work” or as “old work” boxes. Specialty types also accommodate attachment to wallboard as spaced between adjacent studs. Among related patents for angled mounting of fasteners include U.S. Pat. Nos. 5,600,093 and 7,259,327, both of Herth. Among related patents for electrical work boxes with slide-in slotted mounting blocks for fasteners include U.S. Pat. Nos. 7,378,590 and 7,554,032, both of Herth. U.S. Pat. No. 4,304,957 of Slater shows rotating a screw to causing a pawl and wing to rotate upon turning and U.S. Pat. No. 3,966,152 of Bromberg shows pivoting wings for use when a box is to be mounted on wallboard or any wall covering away from a stud, wherein rotating wings rotate 90 degrees away from the box wall and sandwich the wallboard between the tightened wings and the flush flanges.

### OBJECTS OF THE INVENTION

It is therefore an object of the present invention to provide a universally mounted electrical boxes for old work and new work, whether stud-mounted or not.

It is also an object of the present invention to provide a single electrical box type incorporating multiple mounting alternatives for both old work and new work.

Other objects which become apparent from the following description of the present invention.

### SUMMARY OF THE INVENTION

This invention relates to a universal type of box that is equally well suited for attachment to studs for new work, or for old work whether stud-mounted or not. Although available in a variety of sizes and shapes, the universal mounting is what distinguishes the electrical box of this invention from prior art boxes.

For mounting to studs, molded fastener blocks which guide screw fasteners at an angle from the interior of the box can be used. Alternatively, slide-in fastener plates which have integral fastener blocks can be used instead. Optional recessed flanges are provided to properly space the open end of the box from the front surface of a stud for new work use, and they can also be used for box attachment in lieu of internal fasteners. These flanges are easy break-away types for removal to permit the same box to be used for old work. Flanges mounted flush with the open face of the box are used for old work whether stud mounted or not. These too are break-away types for easy removal when a box is used for new work.

When a box is to be mounted on wallboard or any wall covering away from a stud, rotating wings which rotate 90 degrees away from the box wall and sandwich the wallboard between the tightened wings and the flush flanges are used. While all individual mounting features are to be found in the prior art, no single box type incorporating all three mounting alternatives predates the current invention.

### BRIEF DESCRIPTION OF THE DRAWINGS

The present invention can best be understood in connection with the accompanying drawings. It is noted that the invention is not limited to the precise embodiments shown in drawings, in which:

FIG. 1 is a rear perspective view of a single gang universal mount rectangular electrical box of this invention;

FIG. 2 is a front perspective view of the box of FIG. 1;

FIG. 3 is a rear perspective view of a universal mount round electrical box of this invention;

FIG. 4 is a front perspective view of the box of FIG. 3;

FIG. 5 is a perspective view of the rotating wing used with the round box of this invention;

FIG. 6 is a perspective view of a six gang universal mount electrical box of this invention;

FIG. 7 is a detail perspective view of the mounting features on the interior of a flat wall of an electrical box which interlock with slide-in fastener plates to facilitate attachment to a stud;

FIG. 8 is a front elevation of a fastener plate with 3 integral fastener blocks;

FIG. 9 is a front elevation of a fastener plate with a single integral fastener block; and,

FIGS. 10A, 10B and 10C are illustrations of the three methods of use of a universal mount electrical box of this invention, wherein FIG. 10A is a perspective view of a stud mounted new work box, FIG. 10B is a front elevation view of a stud mounted old work box, and FIG. 10C is a front elevation view of a wallboard mounted old work box.

### DETAILED DESCRIPTION OF THE DRAWINGS

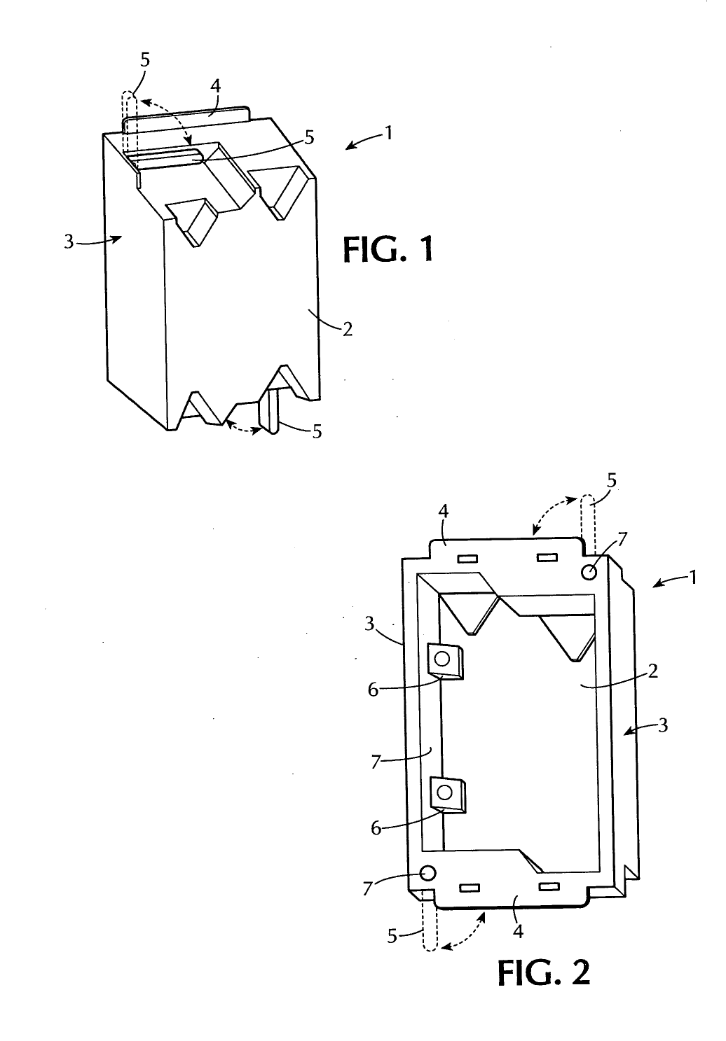

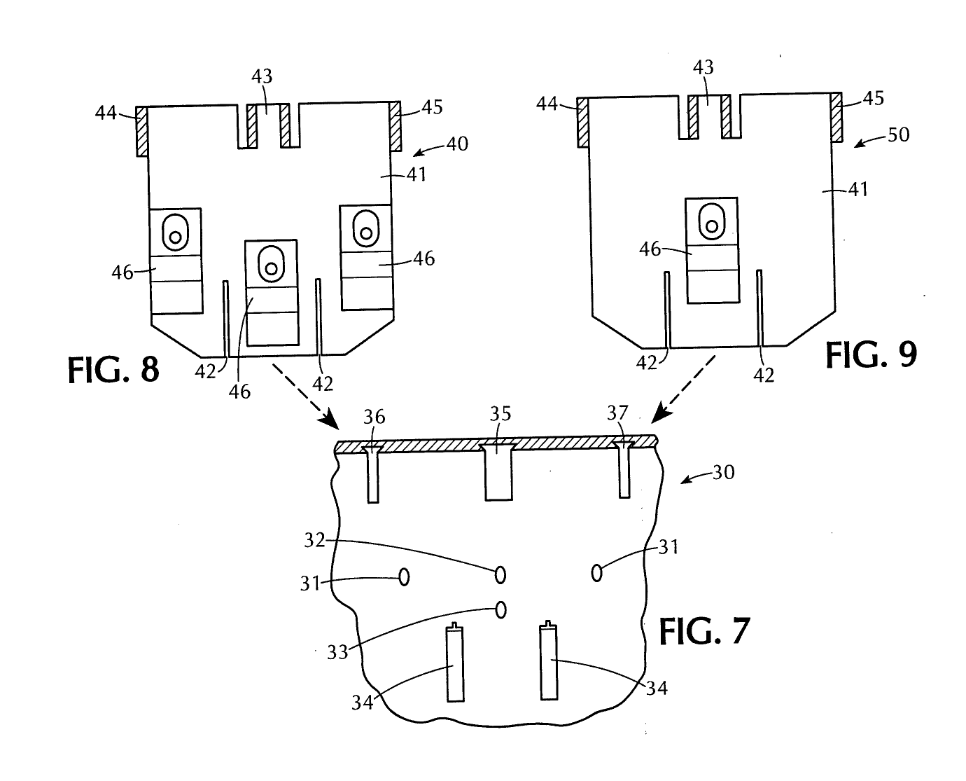

FIGS. 1 and 2 illustrate a single gang rectangular universal mount electrical box 1. For new work, surface mount flanges 4 are broken off prior to attachment to a stud with proper open edge offset using the molded-in angled fastener blocks 6. (Alternative slide-in fastener plate features are shown in FIG. 7.) For old work attachment to a stud, flanges 4 are kept in place and a rectangular hole in wallboard adjacent to the stud is cut. Fasteners are then installed through the front opening to attach box 1 to stud (rotating wings 5 are both set against box prior to installation as shown in the top wing in FIG. 1). For attachment to wallboard away from a stud, wings 5 are set against side of box. A rectangular hole to accommodate box 1 is then cut at the desired location. Box 1 is then pushed into hole with flush flanges tight against the wall. Adjustment screws 7 are then turned which flip out wings 5 at 90 degrees to box sides, and continued tightened will advance the wings forward until they press hard against the inside of the wallboard.

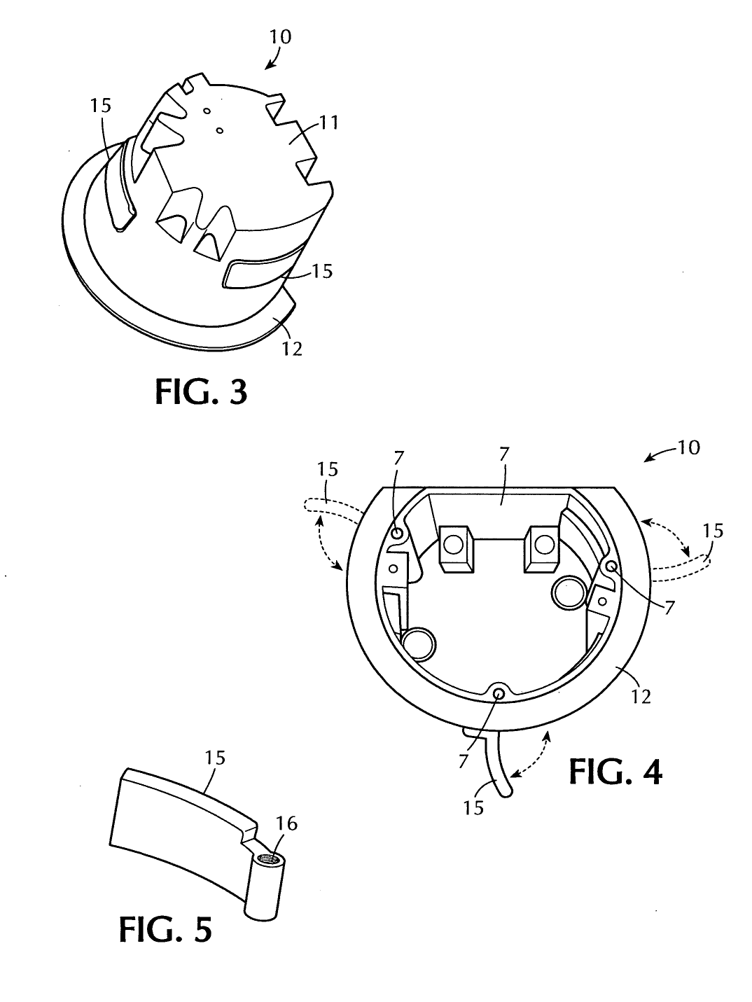

FIG. 3 shows the back of round box 10 with universal mounting features. FIG. 4 shows the front inside view. Housing 11 attaches to break-away flange 12 mounted at the open surface. Here, three curved wings 15 (see FIG. 5) are used spaced around the periphery. Note that hole 16 is threaded to engage with screws 7. Wings 15 are normally parked adjacent to the curved wall of housing 11 as shown in FIG. 3. Molded-in fastener blocks 6 are shown against the flat inner wall for use when attaching to a stud for either new or old work; flange 12 is removed for new work. (Alternative slide-in fastener plate features are shown in FIG. 7.) For attachment to wallboard away from a stud, the three wings 15 are used in a manner similar to the use of wings 5 on the rectangular box 1.

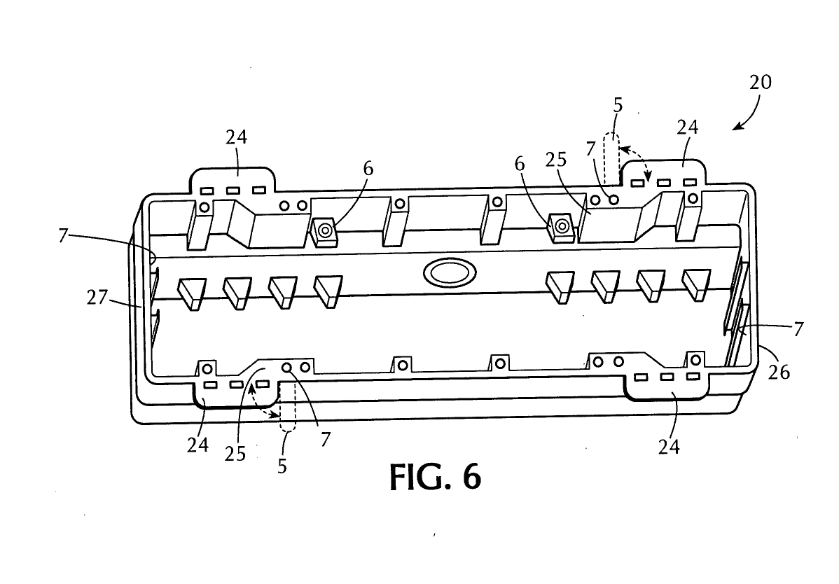

FIG. 6 shows a 6-gang rectangular box 20 with universal mounting features. This large electrical box is designed to be attachable to a stud against the two end short sides (horizontal placement) or against a long side (vertical attachment). The molded-in fastener blocks 6 permit stud attachment to the long wall. End attachment to either side 27 (using recessed flanges 22) or side 26 (using recessed flange 23) is accomplished using fasteners through the flanges themselves or a slide-in fastener block plates as will be described in FIGS. 7-9. For old work attachment to a stud, all recessed flanges 22 and 23 must be removed prior to installation. For new work stud attachment, surface flanges 24 must be removed prior to installation. For attachment to wallboard away from a stud, all recessed flanges must be first removed. Then with wings 5 in their resting position inside housing pockets 25, box 20 is inserted through rectangular hole in wallboard with flanges 24 against outer surface. Then screws 7 are rotated to deploy wings 5 and tighten them against the inside surface of wallboard sandwiching wallboard between flange and wing.

The use of slide-in fastener block plates is illustrated by FIGS. 7-9 which are representative of the preferred embodiment. As can be envisioned, many alternative mounting details can be used, but the objective of providing molded-in attachment features on the inside wall of the electrical box adjacent to the stud compatible with mounting features on the fastener block plates must be realized. This alternative to molded-in fastener blocks reduces the cost of the basic electrical box whereby the mounting blocks are not included if they are not to be used for an installation. Also, the interior volume devoted to the molded-in blocks is eliminated providing more space for electrical equipment and wiring.

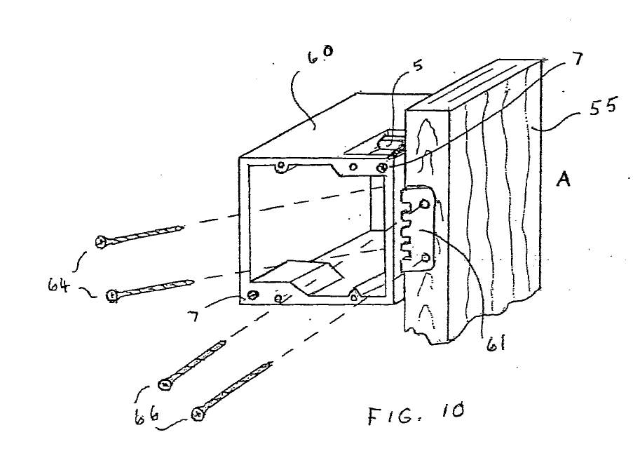

FIG. 7 shows a detail of the mounting features molded onto the inside surface of the mounting wall of the electrical box. For example, these features can be incorporated inside box 1 as indicated in FIG. 2, on the inside of the flat wall of round box 10 as shown in FIG. 4, or on the inside of end walls 26 or 27 of box 20 in FIG. 6. Either 3-block plate 40 (FIG. 8) or single block plate 50 (FIG. 9) are compatible with the features of FIG. 7. Slots 42 are spaced to slide into engagement with T-rails 34 while dovetail block 43 engages recess 35 with angular sides at the top edge of the box wall. Angular slots 36 and 37 receive beveled wing elements 44 and 45 respectively. In this way, plate 41 of block plate 40 or 50 can be easily and precisely installed in a box wall with the features of FIG. 7 so that angled fastener holes 31 would be in registration with 3 blocks 46 for block plate 40, or angled hole 32 would be in registration with single fastener block 46 for block 50. Once a single fastener is used in any fastener block, the respective fastener block plate is locked in place and cannot be withdrawn.

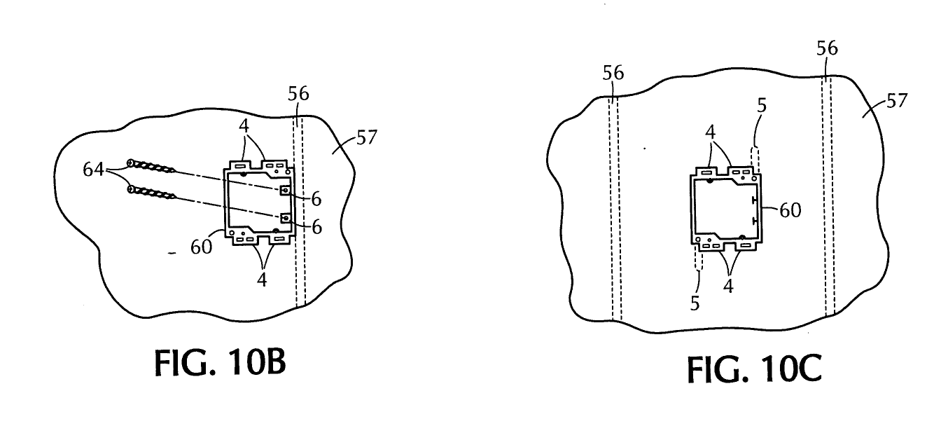

A two bay rectangular (“square”) universal mount box 60 is used to illustrate the three methods of use of such a box of this invention in FIG. 10. In the new work method of FIG. 10A, box 60 is attached to exposed stud 55 in a new work application. In this method, surface mounted break-away flanges 4 (as seen in FIGS. 10B and 10C) have been removed. Recessed break-away flange 61 is set against the face of stud 55 to locate open edge of box 60 somewhat forward of stud surface to account for later installed wallboard thickness. For fastening, two different options are shown: fasteners 66 can be used to attach box 60 via holes in flange 61, or fasteners 64 can be used from the inside of box 60 through angled guides within.

In the stud mounted old work method of FIG. 10B, box 60 is attached to a hidden stud 56 which is covered by wallboard 57. Fasteners 64 are used through angled guides within. These are shown as molded-in guides 6 although mounting wall features as in FIG. 7 to accept a slide in plate with molded guides can be used as an alternative. Note that break-away recessed flange 61 had been removed prior to installation.

In the wallboard mounted old work method of FIG. 10C, box 60 is mounted to wallboard 57 in an area distant from studs 56. In this method, swinging wings 5 are rotated out of their recesses by turning screws 7 on which they are threaded. Once turned at right angles to the outer surface of box 60, wings 5 are constrained to against further rotation, but further turning of screws 7 will cause blocks 5 to approach the inside surface of wallboard 57 whereby box 60 will be securely fastened by virtue of the wallboard being sandwiched between flush flanges 4 and the contacting surface of wings 5. Note that break-away recessed flange 61 had been removed prior to installation.

It is further known that other modifications may be made to the present invention, without departing the scope of the invention, as noted in the appended Claims.

I claim:

1. A universally mountable electrical box for both old work and new work construction, comprising:
one or more outer walls each with a front edge forming a front opening into said electrical box, and at least one flat wall;
one or more surface mount breakaway surface flanges extending outwardly from said front edge, said surface flange allowing said electrical box to be attached to a wallboard without support of a stud in old construction work, and said surface flange being broken away for attachment of said electrical box to a stud in both old and new work construction;
said electrical box further having breakaway recessed flanges on the short sides for properly aligning and spacing said box from a stud when attached to said stud in new work construction, said recessed flanges being removed for old work construction when said electrical box is attached to said wallboard and away from said stud;
at least one rotatable wing hinged inside said outer wall of said electrical box, said wing having an initial position resting within a recess in an outer surface of said outer wall so that said wing does not protrude from the outer surface of said wall, with a hinge member accessible through a threaded opening in or adjacent said front edge;
said hinge member having a threaded opening to receive a tool to rotate said hinge member to flip said wing out of its recess and to move said electrical box forward to press said electrical box against the inside of said wallboard through which said electrical box extends whereby said electrical box becomes attached to said wallboard away from a stud; wherein said wing rotates 90 degrees from the wall of said box, wherein further a ridge prevents further rotation of wings, wherein further continued use of a screw driver causes the screw to progress through said threaded opening in said wing, moving said wing forward toward the wallboard;
said electrical box having a removable slide-in means for attaching said electrical box to a surface of a stud when adjacent to said stud, or to a wall panel;
in which said attaching means further includes said at least one flat wall having rails to receive a slide-in fastener plate, said fastener plate having at least one molded-in angled fastener block, said at least one flat wall having an angled fastener hole in registration with a fastener hole in said fastener block when deployed in said electrical box, thereby providing more available space within said electrical box when a fastener for a stud is not required.

2. The electrical box of claim 1 in which said one flat wall has angular slots to receive to receive beveled wing elements on said slide-in fastener plate for securing said plate in place.

3. The electrical box of claim 1 in which said electrical box is rectangular in shape, having flat upper and lower walls, and flat side walls, with oppositely facing walls each containing a wing.

4. The electrical box of claim 3 in which said rectangular electrical box is square in shape.

5. The electrical box of claim 1 in which said electrical box is substantially circular in shape, with the outer wall thereof containing at least two spaced wings.

6. The electrical box of claim 1 in which said electrical box is elongated and has multiple bays, having a pair of oppositely facing short sides, and a pair of oppositely facing long sides, adapted to be attached to a stud along a short side for horizontal placement, or attached to a stud along a long side for vertical placement.

7. A universally mountable electrical box for both old work and new work construction, comprising:
one or more outer walls each with a front edge forming a front opening into said electrical box, and at least one flat wall;
one or more surface mount breakaway surface flanges extending outwardly from said front edge, said surface flange allowing said electrical box to be attached to a wallboard without support of a stud in old construction work, and said surface flange being broken away for attachment of said electrical box to a stud in both old and new work construction;
said electrical box further having breakaway recessed flanges on the short sides for properly aligning and spacing said box from a stud when attached to said stud in new work construction, said recessed flanges being removed for old work construction when said electrical box is attached to said wallboard and away from said stud.
at least one rotatable wing hinged inside said outer wall of said electrical box, said wing having an initial position resting within a recess in an outer surface of said outer wall so that said wing does not protrude from the outer surface of said wall, with a hinge member accessible through a threaded opening in or adjacent said front edge;
said hinge member having a threaded opening to receive a tool to rotate said hinge member to flip said wing out of its recess and to move said electrical box forward to press said electrical box against the inside of said wallboard through which said electrical box extends whereby said electrical box becomes attached to said wallboard away from a stud; and
said electrical box having means for attaching said electrical box to a surface of a stud when adjacent to said stud, or to a wall panel, in which said attaching means comprises molded-in angled fastener blocks.

8. The electrical box of claim 7 in which said electrical box is rectangular in shape, having flat upper and lower walls, a flat rear wall and flat side walls, with oppositely facing walls each containing a wing.

9. The electrical box of claim 8 in which said rectangular electrical box is square in shape.

10. The electrical box of claim 7 in which said electrical box is substantially circular in shape, except for said at least one flat wall and a flat rear wall, with the outer wall thereof containing at least two spaced wings.

11. The electrical box of claim 7 in which said electrical box is elongated and has multiple gangs, having a pair of oppositely facing short sides, and a pair of oppositely facing long sides, adapted to be attached to a stud along a short side for horizontal placement, or attached to a stud along a long side for vertical placement.

12. A universally mountable electrical box for both old work and new work construction, comprising:
one or more outer walls each with a front edge forming a front opening into said electrical box, and at least one flat wall;
one or more surface mount breakaway surface flanges extending outwardly from said front edge, said surface flange allowing said electrical box to be attached to a wallboard without support of a stud in old construction work, and said surface flange being broken away for attachment of said electrical box to a stud in both old and new work construction;
at least one rotatable wing hinged inside said outer wall of said electrical box, said wing having an initial position resting within a recess in an outer surface of said outer wall so that said wing does not protrude from the outer surface of said wall, with a hinge member accessible through a threaded opening in or adjacent said front edge;
said hinge member having a threaded opening to receive a tool to rotate said hinge member to flip said wing out of its recess and to move said electrical box forward to press said electrical box against the inside of said wallboard through which said electrical box extends whereby said electrical box becomes attached to said wallboard away from a stud; and
said electrical box having angled attachment means for attaching said electrical box to a surface of a stud when adjacent to said stud or to a wall panel.

13. The electrical box of claim 12 in which said electrical box is rectangular in shape, having flat upper and lower walls, and flat side walls, with oppositely facing walls each containing a wing.

14. The electrical box of claim 13 in which said rectangular electrical box is square in shape.

15. The electrical box of claim 12 in which said electrical box is substantially circular in shape, with the outer wall thereof containing at least two spaced wings.

16. The electrical box of claim 12 in which said attaching means comprises molded-in angled fastener blocks.

17. The electrical box of claim 13 in which said electrical box is elongated and has multiple gangs, having a pair of oppositely facing short sides, and a pair of oppositely facing long sides, adapted to be attached to a stud along a short side for horizontal placement, or attached to a stud along a long side for vertical placement.

18. The electrical box of claim 17 having breakaway recessed flanges on the short sides for properly aligning and spacing said box from a stud when attached to said stud in new work construction, said recessed flanges being removed for old work construction when said electrical box is attached to said wallboard and away from said stud.

19. The electrical box of claim 12 in which said attaching means includes at least one of said flat walls having rails to receive a slide-in fastener plate, said fastener plate having at least one molded-in angled fastener block, said one of said flat walls having an angled fastener hole in registration with a fastener hole in said fastener block when deployed in said electrical box, thereby providing more available space within said electrical box when a fastener for a stud is not required.

20. The electrical box of claim 19 in which said one flat wall has angular slots to receive to receive beveled wing elements on said slide-in fastener plate for securing said plate in place.
